(19) United States
(12) Patent Application Publication
(10) Pub. No.: US 2011/0252414 A1
(43) Pub. Date: Oct. 13, 2011

(54) System using separate modules to update software and the method thereof

(75) Inventors: Chaucer Chiu, Taipei (TW); Minjie Cai, Shanghai (CN)

(73) Assignee: INVENTEC CORPORATION, Taipei (TW)

(21) Appl. No.: 12/662,755

(22) Filed: May 3, 2010

(30) Foreign Application Priority Data
Apr. 8, 2010 (TW) 099110846

(51) Int. Cl. G06F 9/44

(52) U.S. Cl. 717/173

(57) ABSTRACT

System and method using separate modules to update software separates an update program into a pre-update module and a core module. When the pre-update module determines the existence of an update file corresponding to the core module, the pre-update module first uses the update file to update the core module and then loads the updated core module. The core module thus updates the target file contained in the software. The update program can update itself. The user does not need to update the update program manually.

### BACKGROUND OF THE INVENTION

1. Field of Invention

The invention relates to a software update system and method and, in particular, to a system that uses separate modules to update software and the method thereof.

2. Related Art

Software is a set of computer data and commands organized in a particular order. According to the location of the running host, the software can be divided into local and remote software.

When software has some erroneous procedure, the developer comes up with a procedure with better efficiency or using fewer resources, or the developer wants to enhance its functions, the software needs an update. Since the local software is installed on the client end, its user has to manually update or uses the automatic update function of the software. Therefore, the update program of software is important.

It is more convenient for the user to use the update program of software to update the software. However, the files to be updated are usually stored on a server provided by the vendor. Therefore, the update program has to work with the vendor's server during software update. Once the service procedure running on the server to work with the update program is changed by the developer for some reason, the update program on the client end has to be updated as well. Nonetheless, this has some difficulty in practice. Due to the software properties, the running program cannot be modified. That is, the update program cannot update itself. So if the service procedure running on the server is changed, the update program cannot update the software correctly. In this case, the user has to update the update program manually.

In summary, the prior art always has the problem that the update program of software cannot update itself. It is imperative to provide a solution for this.

### SUMMARY OF THE INVENTION

In view of the foregoing, the invention provides a system and method of using separate modules to update software.

The disclosed system of using separate modules to update software includes: a core module and a pre-update module. The core module is used to update the target file contained in the software. The pre-update module is one of the target files. The pre-update module further includes: a determining unit for determining whether an update file corresponding to the core module exists; an updating unit for updating the core module with the update file when the determining unit determines that the update file exists; and a core loading unit for loading the core module.

In the disclosed system, the pre-update module further includes a user interface for displaying interactive information therein. Moreover, the pre-update module or the core module is used to terminate the pre-update module.

In the disclosed system, the pre-update module further includes a transmitting unit for connecting to the server. The determining unit uses the transmitting unit to determine whether the server stores the update file. The transmitting unit also downloads the update file from the server.

The disclosed method of using separate modules to update software includes the steps of: separating an update program into a pre-update module and a core module; using an update file to update the core module after the pre-update module determines the existence of the update file corresponding to the core module; loading the updated core module by the pre-update module; and updating target files contained in the software by the core module.

The disclosed method further includes the step of displaying a user interface by the pre-update module before the pre-update module determines the existence of the update file for the core module. Besides, there is a step of terminating execution of the pre-update module by the pre-update module or the core module before the step of updating the target files by the core module.

In the disclosed method, the step of determining the existence of an update file for the core module by the pre-update module is done as follows. The pre-update module connects to the server and determines whether the update file is stored in the server. The step of updating the target files contained in the software further includes the steps of updating the pre-update module by the core module. The step of loading the updated core module by the pre-update module is done by loading the updated core module by the pre-update module using the dynamic linking library (DLL) or reflective technique.

As described above, the disclosed system and method differ from the prior art in that the invention first separate the update program into a core module and a pre-update module. When the pre-update module determines the existence of an update file for the core module, the update file is first used to update the core module. Afterwards, the updated core module is loaded. The core module then updates the target files contained in the software. This solves the problems in the prior art and does not need a manual update.

### BRIEF DESCRIPTION OF THE DRAWINGS

The invention will become more fully understood from the detailed description given herein below illustration only, and thus is not limitative of the present invention, and wherein:

FIG. 1 is a schematic view of dividing the update program into two modules according to the invention.

FIG. 2 shows the system structure of the separate modules for software update.

FIG. 3 is a flowchart of the method of using separate module to update software.

FIG. 4A is a schematic view of the program code that uses DLL to load the core module according to the embodiment of the invention.

FIG. 4B is a schematic view of the program code that uses the reflective technique to load the core module according to the embodiment of the invention.

FIG. 5 is a schematic view of the disclosed user interface.

### DETAILED DESCRIPTION OF THE INVENTION

The present invention will be apparent from the following detailed description, which proceeds with reference to the accompanying drawings, wherein the same references relate to the same elements.

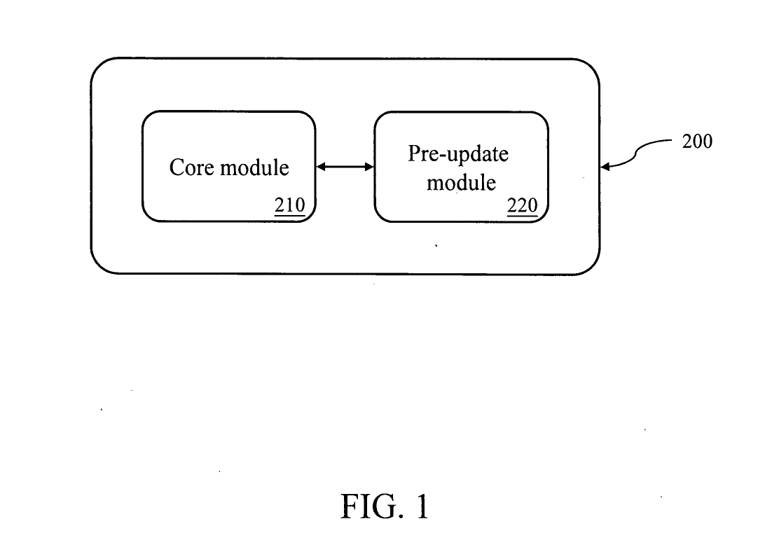

As shown in FIG. 1, the update program 200 of software is divided from a complete module into two modules with different functions. One or two of the two modules contain the function of updating the other module. In fact, the invention is not limited to the possibility of dividing the update program into two modules. As long as a complete update program is divided into two or more modules and any of the modules can update the others, these embodiments should be included as part of the invention.

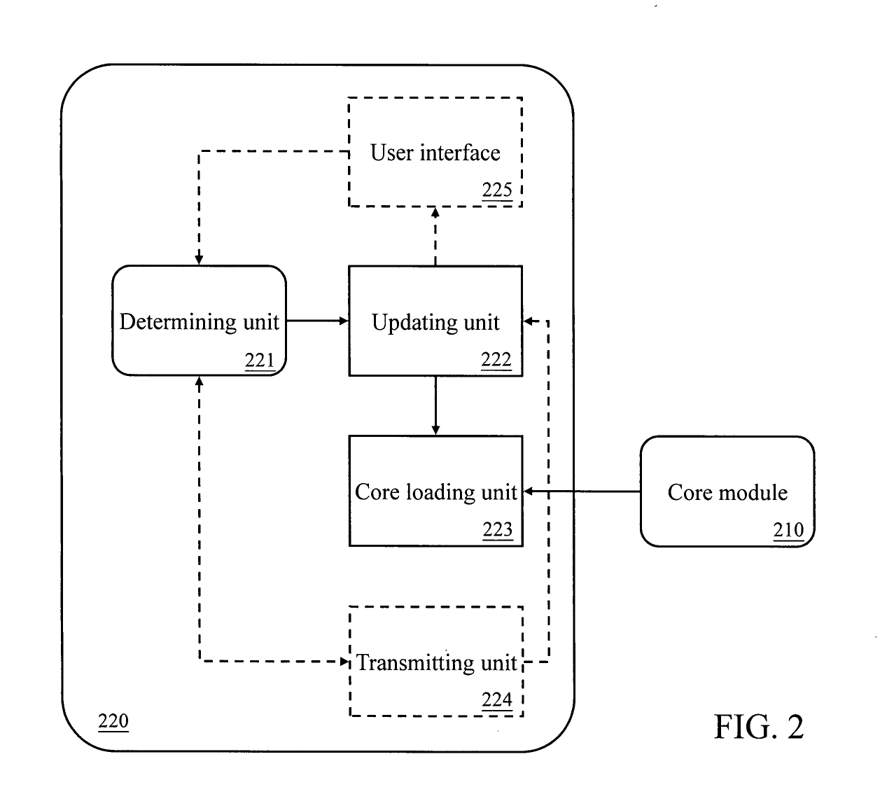

FIG. 2 shows the system structure that uses separate modules to update software. As shown in the drawing, the disclosed system includes a core module 210 and a pre-update module 220.

The core module 210 updates target files in software in the conventional manner, such as manual update by the user or the automatic update program of the software. The target files to be updated by the core module 210 are usually contained in the disclosed software and do not belong to other programs of the update program 200. However, the invention is not limited to this case. In practice, the target files may even include the pre-update module 220, but not the core module 210.

It should be mentioned that the programs not belonging to the update program 200 in the software are all updated by the core module 210. Therefore, the core module 210 is the most important component of the update program 200.

The pre-update module 220 is mainly used to update the core module 210 before loading the core module 210. To achieve this function, the pre-update module 220 includes at least a determining unit 221, an update unit 222, and a core loading unit 223.

The determining unit 221 determines whether an update file for the core module 210 exists. The update file here is the file used to update the core module 210. It should be mentioned that the update file can be stored in the environment where the disclosed software runs (the local side) or the remote server. When the update file is stored on the local side, the determining unit 221 can use the file system on the local side to determine whether the update file exists. When the update file is stored on the server, the determining unit 221 can use the transmitting unit 224 to connect to the server and determine whether the update file exists.

Whether the update file is stored in the running environment of the software or on a remote server, the determining unit 221 can determine whether the update file for the core module 210 exists by comparing the update dates of the files in the core module 210 with the date of the update file. Alternatively, determining unit 221 can compare the version number of the core module 210 recorded in the setting file at a specific storage location on the local side with the version number recorded in the update file to determine whether an update file for the core module 210 exists. Furthermore, determining unit 221 can even check whether the file of a specific filename exists at a particular storage location on the local side. For example, the filename is the date of previous update. However, the method of checking the existence of an update file used by the determining unit 221 is not limited to these possibilities.

The transmitting unit 224 connects to the server that stores update files. After the determining unit 221 determines the existence of an update file, transmitting unit 224 downloads the update file from the server and stores the update file at a particular location on the local side. For example, there is a directory that stores update files. The invention is not limited to this possibility. Besides, the transmitting unit 224 also allows the determining unit 221 to determine whether the update file exists via its connection to the server.

After the determining unit 221 determines the existence of an update file for the core module 210, the updating unit 222 reads the update file for the core module 210, and uses the update file to update the core module 210. The updating unit 222 can follow a default storage path to read the update file of a default filename. The updating unit 222 can also read the update file following the storage path and filename recorded in the system setting file. However, the method of reading the update file by the updating unit 222 is not limited to these examples.

The updating unit 222 can directly replace the files of the core module 210 with the update file, or use the data recorded in the update file to modify or delete specific files in the core module 210, thereby updating the core module 210. Nonetheless, the method of updating the core module 210 by the updating unit 222 is not limited to these examples.

The core loading unit 223 loads the core module 210 for the core module 210 to run. When the determining unit 221 determines the existence of the update file for the core module 210, the core loading unit 223 loads the core module 210 after the updating unit 222 updates the core module 210. If the determining unit 221 does not find the update file for the core module 210, the core module 210 is directly loaded.

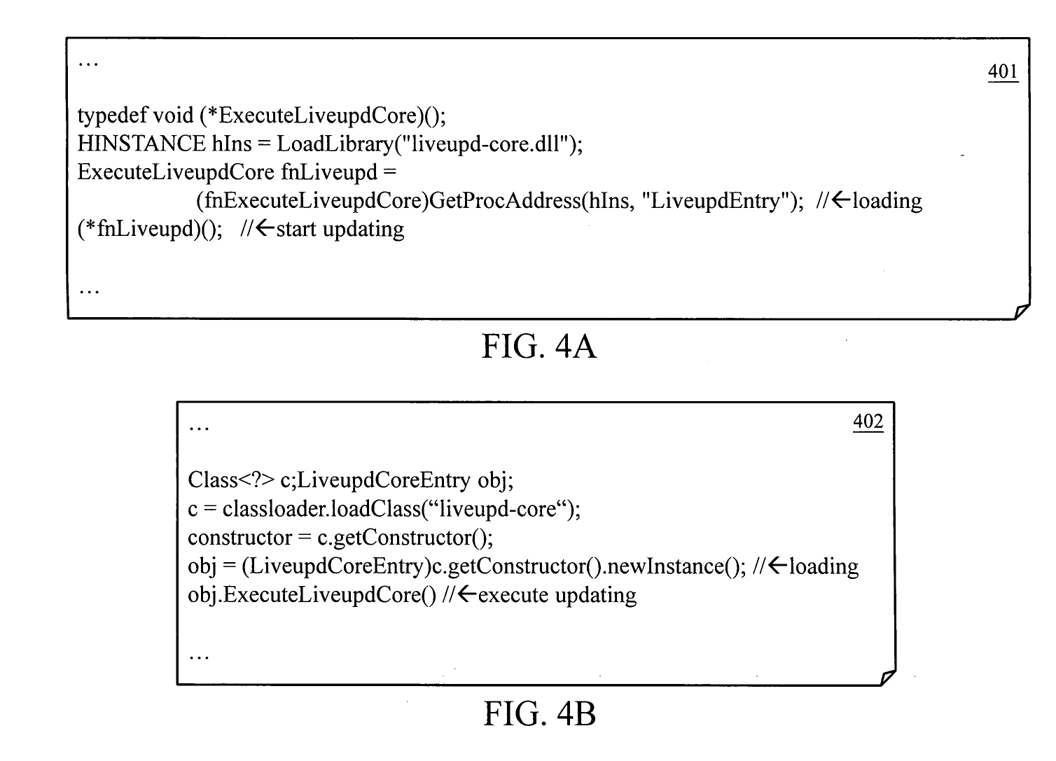

It should be noted that the core loading unit 223 completes the update of the most important part of the update program 200 by delaying the load of the core module 210. The core loading unit 223 loads the core module 210 differently for different software developing platforms. For example, the core loading unit 223 can include the program code 401 shown in FIG. 4A. The program code 401 loads the core module 210 using the dynamic linking library (DLL). Alternatively, the core loading unit 223 can also include the program code 402 in FIG. 4B. The program code 402 loads the core module 210 using the reflective technique. However, the method of loading the core module 210 by the core loading unit 223 is not limited to the above two examples.

Moreover, the pre-update module 220 of the invention can further include a user interface 225. The pre-update module 220 uses the user interface to display interactive information to interact with the user. The user interface 225 is not limited to this function. The interactive information includes software update status, percentage of file download, etc. The invention is not limited to these examples.

The user interface 225 further allows the user to enter a triggering signal for software update. For example, there is an update key in the user interface 225. When the user clicks the update key, the triggering signal for software update is sent out. The determining unit 221 then determines whether an update file for the core module 210 exists after receiving the triggering signal.

Besides, the pre-update module 220 or the core module 210 can terminate the execution of the pre-update module 220. For example, after loading the core module 210, the core loading unit 223 does not have any other function. The pre-update module 220 starts the release procedure contained therein to terminate its execution. When the pre-update module 220 needs to be updated, the core module 210 calls the procedure to terminate the pre-update module 220.

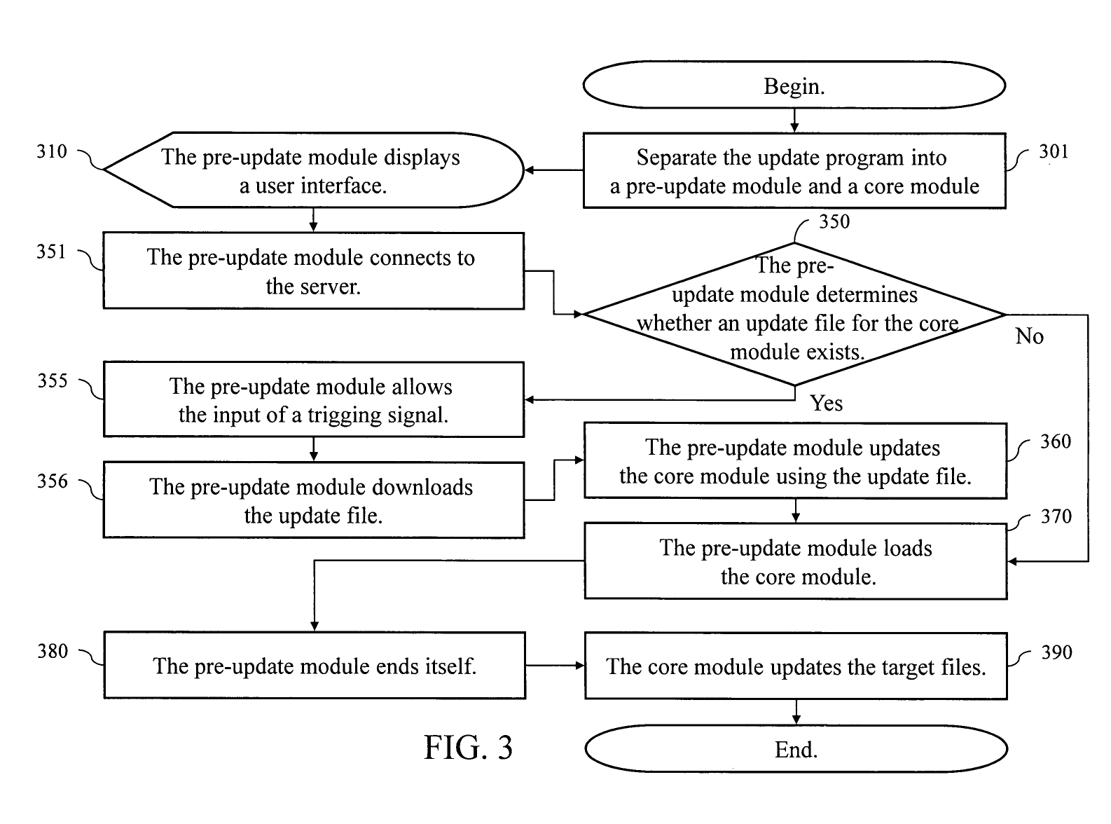

The following uses an embodiment to explain the operating system and method of the invention. Please refer to FIG. 3 for the flowchart of the disclosed method. In this embodiment, the software records health conditions. The invention is not limited to this example though.

When a user clicks to run the health condition recording software in a running environment, the health condition recording software first updates its version. In this case, the update program 200 of the health condition recording software starts.

If the update program 200 makes use of the invention, then the update program 200 is divided by the developer into a core module 210 and a pre-update module 220 (step 301). After the update program 200 starts, the determining unit 221 of the pre-update module 220 first determines whether an update file for the core module 210 exists (step 350). Suppose in this embodiment that the update file for the core module 210 is stored in the server provided by the health condition recording software vendor, the determining unit 221 first connects to the server that stores the update file for the core module 210 via the transmitting unit 224 of the pre-update module 220 (step 351). If the determining unit 221 determines via the transmitting unit 224 that the server provided by the health condition recording software stores the update file, then the determining unit 221 reads the last update date of the update file recorded on the server. Suppose the date is ‘2009/4/13’. Afterwards, the determining unit 221 compares the last update date ‘2009/4/13’ recorded in the update file of the server with the last update date ‘2009/2/8’ of the core module 210, and determines the update file for the core module 210 on the server. Therefore, the transmitting unit 224 downloads the corresponding update file for the core module 210 from the server (step 356), and stores the update file in the running environment of the health condition recording software.

After the determining unit 221 of the pre-update module 220 determines the existence of the update file for the core module 210 (step 350), the updating unit 222 of the pre-update module 220 reads the update file for the core module 210 in the running environment of the health condition recording software, and uses the update file to update the core module 210 (step 360).

After the updating unit 222 of the pre-update module 220 updates the core module 210, the core loading unit 223 of the pre-update module 220 loads the core module 210 (step 370). The core module 210 updated by the updating unit 222 starts running, updating the target files of the health condition recording software (step 390). The core module 210 in the disclosed update program 200 that updates the target files of the health condition recording software is thus updated. This prevents the problem of unable to update the core module 210 of the update program 200 because the update program 200 is running.

In the above embodiment, if the updated target files include a file for the pre-update module 220 when the core module 210 updates the health condition recording software, the core module 210 terminates the execution of the pre-update module 220 in order to facilitate the update of the pre-update module 220 (step 380).

In summary, the invention differs from the prior art in that the update program 200 is divided into a pre-update module 220 and a core module 210. When the pre-update module 220 determines that the update file for the core module 210 exists, the update file is first used to update the core module 210. The updated core module 210 is then loaded. The core module 210 thus updates the target files contained in the core module 210. This technique solves the problem in the prior art that the update program cannot update itself and the user has to manually do the update program.

In the above embodiment, if the update file for the core module 210 is downloaded by the user and directly stored in the running environment of the health condition recording software, the determining unit 221 directly reads the update file version stored in the running environment according to the file system thereof. Suppose the version of the update file is ‘8.4.13’, and the version of the core module 210 recorded in the system setting file is ‘8.2.8’. The determining unit 221 determines that the running environment of the health condition recording software has an update file for the core module (step 350). Therefore, the updating unit 222 in the pre-update module 220 reads the update file for the core module 210 from the running environment of the health condition recording software, and uses the update file to update the core module 210 (step 360).

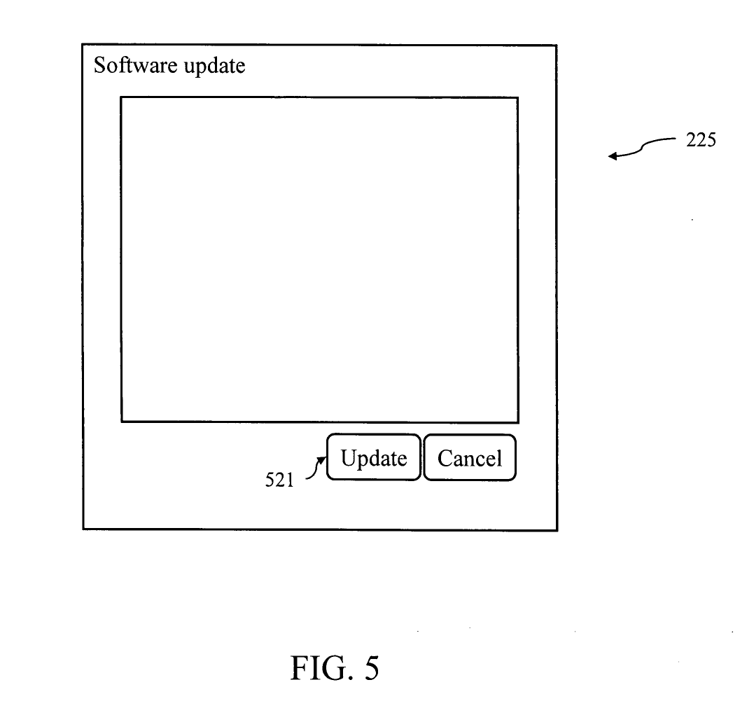

Besides, if the pre-update module 220 contains a user interface 225, then after the determining unit 221 of the pre-update module 220 determines whether there is an update file for the core module 210 during the update process of the health condition recording software (step 350) the pre-update module 220 can generate the user interface 225 shown in FIG. 5 (step 310). Afterwards, the user can click the ‘update’ key 521 shown in the user interface 225 to enter a trigging signal of updating software (step 3550. Thus, subsequent steps are followed. In practice, the pre-update module 220 can first provide the ‘update’ key in the user interface 225 for the user to click after the user interface 225 is generated (step 310), thereby generating a trigging signal (step 355). Afterwards, step 350 determines whether the update file for the core module 210 exists (step 350).

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of using separate modules to update software used in an update program of software, comprising the steps of:
separating the update program into a pre-update module and a core module;
after determining the existence of an update file for the core module by the pre-update module, using the update file to update the core module;
loading the updated core module by the pre-update module; and
updating at least one target file contained in the software by the core module.

2. The method of using separate modules to update software of claim 1, wherein the step of displaying a user interface by the pre-update module precedes the step of determining the existence of an update file for the core module by the pre-update module.

3. The method of using separate modules to update software of claim 1, wherein the step of determining the existence of an update file for the core module by the pre-update module determines the existence of the update file by connecting the pre-update module to a server and checking whether the server stores the update file.

4. The method of using separate modules to update software of claim 1, wherein the step of updating the target file contained in the software further includes the step of updating the pre-update module by the core module.

5. The method of using separate modules to update software of claim 1, wherein the step of terminating the execution of the pre-update module by the pre-update module or the core module precedes the step of updating the target file by the core module.

6. The method of using separate modules to update software of claim 1, wherein the step of loading the updated core module by the pre-update module is achieved by loading the updated core module by the pre-update module using the dynamic linking library (DLL) or reflective technique.

7. A system of using separate module to update software used in an update program of software, comprising:
a core module for updating at least one target file contained in the software; and
a pre-update module as one of the target files and including:
a determining unit for determining the existence of an update file for the core module;
an updating unit for using the update file to update the core module when the determining unit determines the existence of the update file; and
a core loading unit for loading the core module.

8. The system of using separate module to update software of claim 7, wherein the pre-update module further includes a user interface for displaying interactive information therein.

9. The system of using separate module to update software of claim 7, wherein the pre-update module further includes a transmitting unit for connecting to a server, the determining unit uses the transmitting unit to determine whether the server stores the update file, and the transmitting unit downloads the update file from the server.

10. The system of using separate module to update software of claim 7, wherein the pre-update module or the core module terminates the execution of the pre-update module.
